(19) United States
(12) Patent Application Publication
(10) Pub. No.: US 2002/0070960 A1
(43) Pub. Date: Jun. 13, 2002

(54) Multimedia appliance

(76) Inventors: Stephen G.T. Maine, Paradise Valley, AZ (US); Christopher Porter, Scottsdale, AZ (US); John Berkheimer, Scottsdale, AZ (US); Christopher Chevalier, Tempe, AZ (US); Chuck Kraft, Cave Creek, AZ (US); Fergus Pollard, Scottsdale, AZ (US)

Correspondence Address: Damon L. Boyd, Snell & Wilmer L.L.P., One Arizona Center, 400 East Van Buren, Phoenix, AZ, 85004-2202, US

(21) Appl. No.: 09/907,395

(22) Filed: Jul. 17, 2001

Related U.S. Application Data
(60) Provisional application No. 60/218,603, filed on Jul. 17, 2000.

(51) Int. Cl. G09G 5/00

(52) U.S. Cl. 345/723

(57) ABSTRACT

The present invention is directed to an multimedia appliance. The media appliance is suitably seamless, that is, transparent to the user, through its interconnection, control, signal routing, multimedia content management, and the like. In accordance with one aspect of the invention, the media appliance enables the viewing, listening, multimedia searching and fetching and similar functions while simultaneously providing the ability to record or store other multimedia content through a single user interface.

A media appliance of the present invention includes a disc-playing mechanism and a drive for storage. The storage drive may be a magnetic memory, such as a hard drive. The disc-playing mechanism may be an optical disc carrier. A media appliance may also incorporate connectivity to the Internet to facilitate the transmission and receipt of various file formats for audio and video reproduction. The media appliance may be coupled to a television monitor to display images transmitted by the media appliance. The media appliance may also be coupled to one or more speakers for the reproduction of audio signals.

### CROSS-REFERENCE TO RELATED APPLICATIONS

This application claims the benefit of provisional application serial No. 60/218,603, filed Jul. 17, 2000.

### BACKGROUND OF THE INVENTION

1. Field of the Invention

This application relates generally to multimedia devices and more particularly to a multimedia appliance that performs a variety of content manipulation functions.

2. Background

Before the late 19th century the only manner in which to listen to music was by live performance. That changed in the late 19th century and early 20th century with the popularization of the phonograph. The phonograph allowed people to listen to famous performers and compositions of music in the comfort and privacy of their own home. The phonograph went through a series of evolutions including changes from the foil cylinder, to the 78-rpm shellac disc, to the 33⅓ rpm vinyl disc.

The advent of analog magnetic recording also eased the manner in which consumers could listen to and record music, from open-reel tape recorders, to 8-track tape recorders, to the modern analog cassette recorder.

In the 1980s, the popularization of digital recording and media delivery marked a further change in the delivery format of music: the 12 centimeter compact disc eventually became the primary form of music products purchased in the United States.

As for the home recording of music, while the analog audiocassette remains the dominant form in this country, higher quality duplication is becoming more popular with each passing year. While Digital Audio Tape (“DAT”) and the MiniDisc were the first forms of digital recording available to consumers and today, the newest form of digital recording to gain widespread popularity is the recordable CD, popularly known as CD-R, and the re-writable CD, popularly known as CD-RW. With a CD-R, a consumer can create their own disc that contains the music that the consumer wishes to hear. Unlike an analog audiocassette, however, a CD-R, if created with the proper equipment, contains a near-perfect digital replica of the digital information stored on an audio CD, thus resulting in a negligible loss in sound quality.

Another area of recording to gain popularity in recent years is MPEG-1, layer 3 (“MP3”) encoding, which compresses sound files to as little as 10% of the original size, allowing the storage of many more musical works in a given amount of memory than uncompressed CDs. Although, at one time, one could only play back an MP3 file on a computer, there are now CD players on the market which will play MP3 files stored on a CD-R.

Many advances in the movie industry have also occurred in recent years. At the beginning of the 20th century, movies were silent and black and white. Within a few decades, movies had sound and were available in color. However, movies still had to be viewed in a movie theater. While a movie theater has several advantages over the television set, including the larger picture size and the controllably dark venue, there are various inconveniences present in movie theaters, including the possibility of loud, large crowds, and the relatively high expense of drinks and food items, compared to the costs of those items at grocery stores and the like.

The advent of the videocassette recorder and videotape rental facilities, such as Blockbuster Video, resulted in various changes in the movie industry. Consumers became able to view movies in the privacy of their home on their television sets, without being interrupted by commercials. Consumers also have the ability to choose the timing of the viewing of the movies. They could also stop the movie to, e.g., take a phone call; rewind a portion of the movie to rehear a line of dialog they missed; and they could eat and drink foods and drinks at a lower cost than the overpriced fare typically present at movie theaters. These changes have resulted in the addition of billions of dollars of revenue to the distributors of movies.

As with the music industry, the movie industry is trending towards digital delivery of its products, with the recent commercial success of DVD (digital versatile disc). The DVD presents many of the convenience features that enabled the CD to overtake the audiocassette in popularity, such as quick access to scenes; higher quality of both audio and video; and a medium that does not degrade with normal use.

With regards to broadcast and cable television, the VCR has played additional roles, such as time-shifting and archiving. Time-shifting allows consumers to tape a television program and watch it at a later time. Archiving allows consumers to save, for example, home movies made with a camcorder.

There have been several advances in VCRs in recent years. For example, digital VCRs, which record the video and audio signals in a digital format, have recently become popular in camcorders.

In the arena of television, digital cable and digital satellite are making inroads in the home as a newer delivery medium of television signals, providing a high-quality signal and the possibility of greater viewing choices. In addition, the videocassette recorder has recently been joined by new competition in the recordation of television shows.

The popularization of the Internet, coupled with various file compression formats, has also resulted in many changes in the audio and video fields. For example, it has now become very easy to send still photographs to locations around the world (e.g., using the JPEG format). Similarly, it has also become much easier to send audio files (e.g., using MP3 compression or various “streaming” files including, but not limited to, Real Audio®) and video files (e.g., using MPEG-1 or MPEG-2 compression or various “streaming” files including, but not limited to, Real Video®, Quicktime®, and Microsoft Windows MediaTM) to people throughout the entire world.

There are several drawbacks to the recent advances in audio/video technology described above. One problem with the advent of new technology is that each particular format requires different signal processing systems and one must typically purchase a separate unit for each particular format. The number of products may create a cluttered living area. This is shown in FIG. 1, which presents an exemplary audio/video system 100, which contains a large number of audio/visual gear.

A television 102 is used to display the various pictures that may be from broadcast television or from a videocassette recorder 104 or a DVD player 106, a cable box 108, or a PVR 110. The audio signals would be presented through a pair of speakers 112 and 114. The speakers receive a signal from a power amplifier 116. Power amplifier 116 is configured to convert line-level signals to a signal usable by speakers 112 and 114. The line-level signals are received from a pre-amplifier 118. Pre-amplifier 118 operates to switch signals from various sources, such as an AM/FM radio tuner 120, a cassette deck 122, or a CD player 124. A user may substitute a surround sound decoder (not shown) for pre-amplifier 118 if the user is desirous of playing back audio over a surround sound speaker system (not shown).

In addition to the products described above, a user must also have various types of wires to interconnect the various pieces of equipment. Because of the number of wires needed, there is a potential for a higher cost, a potential for user confusion due to the number of wires and the connections to be made, and a potential for wire clutter.

An additional problem is the difficulty of modern audio/video equipment is the difficulty in learning to use the multiplicity of products. There may be a number of different units, possibly from different manufacturers, that each need to be learned, and a number of different remote controls to use. Another problem with the new technology is the obsolescence of older technology. For example, older CD players have no capability to record onto CD-R and CD-RW and may have problems with reading a CD-R or a CD-RW. In addition, many current CD players have no capability to play a CD-R or CD-RW containing compressed MP3 files. Furthermore, in order to play DVDs, one must have a DVD player. Consumers need a single appliance that is extremely easy to install, easy to use, and requires virtually no learning.

Another problem is the lack of upgradability in most of today's products. While several manufacturers, such as Madrigal, create “modular” units with replaceable parts, those products are generally very expensive. A related problem is obsolescence. Once a new format is in the market, a consumer's existing equipment cannot use the new format. For example, a CD player cannot play a DVD. A traditional, video DVD player cannot play the DVD-Audio portion of DVD-Audio discs (although some new DVD-Audio discs contain information that is compatible with traditional DVD players, that information is not the same as the high-quality information that is played back by DVD-Audio players). In addition, certain DVD players cannot play CD-R discs. There is a need to provide a means of upgrading such that a product is kept current after it is in a customer's hand.

Another difficulty which arises with standard VCRs and other formats is the inability to play back a recorded event from one medium while simultaneously recording another event. For example, a user may wish to view an event such as a rented movie. However, the user may also wish to simultaneously record a television show. With a single-deck VCR, that is not possible. Single deck VCRs require the rented movie to be inserted and played in order to be viewed. Because the cassette is in the only available video cassette carrier, it is impossible to insert a separate cassette for recording the program.

It is desirable to interconnect these mediums so that copies of a recorded event can be made. For example, one might wish to record a home movie and make a copy to give to others or as a back-up copy should the original be damaged or destroyed. The advent of digital recording technologies has made such uses promising since degradation in quality can be drastically reduced.

Another drawback is the fact that the benefits of the Internet are largely unavailable through a person's home entertainment system. Computers are largely independent of home entertainment systems, resulting in the difficulty of incorporating computer audio and video in a home entertainment system. In addition, a user may wish to control an entire home entertainment system from one position, ideally with one remote control.

It would be beneficial to have a product that handled a variety of the above-described functions while occupying a relatively small amount of shelf space. Further still, the ability to distribute the operative components of the multimedia devices to remote locations is likewise desirable. It would also be beneficial to have a product that can be upgraded when new technology becomes available, so that consumers need not replace the entire unit to receive new benefits. It would also be desirable to incorporate Internet connectivity to an integrated Media Appliance.

### SUMMARY OF THE INVENTION

The present invention is directed to a multimedia appliance that satisfies the above-stated needs. The media appliance is suitably seamless, that is, transparent to the user, through its interconnection, control, signal routing, multimedia content management, and the like.

The multimedia appliance generally comprises a user interface and an executive. The executive suitably allows and/or controls the manipulation of data content 106 in accordance with instructions from a user. That is, the user interface allows the user to access appliance and direct it to perform various functions. For example, the user accesses the interface (e.g., through a remote control, keyboard, mouse, etc.) and instructs the appliance to perform a particular function. Generally, the appliance is capable of performing nearly any desirable function through upgrades and add-on hardware and software.

In one embodiment, a media appliance of the present invention includes a disc-playing mechanism and a drive for storage. The storage drive may be a magnetic memory, such as a hard drive. The disc-playing mechanism may be an optical disc carrier. A media appliance may also incorporate connectivity to the Internet to facilitate the transmission and receipt of various file formats for audio and video reproduction. The media appliance may be coupled to a television monitor to display images transmitted by the media appliance. The media appliance may also be coupled to one or more speakers for the reproduction of audio signals.

In accordance with one aspect of the invention, the media appliance enables the viewing, listening, multimedia searching and fetching and similar functions while simultaneously providing the ability to record or store other multimedia content through a single user interface.

In accordance with various aspects of the present invention, the storage drive suitably allows a user of the media appliance to change and/or upgrade the functionality of the appliance. For example, should the user wish to add DVD functionality, appliance software driver directed to such DVD functionality could be loaded onto the storage drive through a variety of means. For example, the software functionality could be loaded on via a CD/DVD-ROM disc through the optical disc carrier or alternatively, through downloading from the internet. Likewise, it should be appreciated that nearly any other functionality could be added to the media appliance. For example, software directed to DVD-audio, MP3, CDs, and the like, may likewise be loaded onto the media appliance to change/upgrade the appliance's functionality.

### BRIEF DESCRIPTION OF DRAWINGS

FIG. 1 is an exemplary audio/visual entertainment system of the prior art;

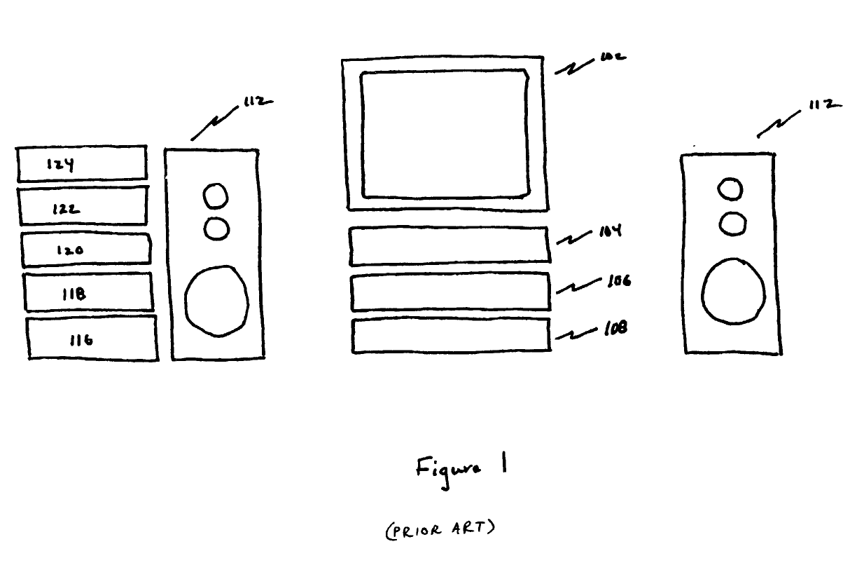

FIG. 2 is a block diagram of an exemplary embodiment of the present invention;

FIG. 3 is an exemplary embodiment of an integrated media appliance and input interface in accordance with the present invention; and

FIG. 4 is a block diagram of an exemplary embodiment of the present invention.

### DETAILED DESCRIPTION OF EXEMPLARY EMBODIMENTS

The following descriptions are of exemplary embodiments of the invention only, and are not intended to limit the scope, applicability, or configuration of the invention in any way. Rather, the following description is intended to provide convenient illustrations for implementing various embodiments of the invention. As will become apparent, various changes may be made in the function and arrangement of the elements described in these embodiments without departing from the spirit and scope of the invention.

Additionally, while various aspects of the description of the present invention are directed to an appliance having a magnetic memory (e.g., a hard drive) and an optical disc carrier, in accordance with various alternative embodiments of the present invention, the multimedia appliance may suitably comprise other sources of multimedia content delivery systems, both remote and local in nature. For example, various analog and/or digital systems including magnetic tape, optical storage, solid-state memory, or any other removable or non-removable media, may be used. Likewise, one or more of these decks may be included into the multimedia appliance.

For example, a personal video recorder (PVR), which enables consumers to record to a hard disk instead of to a video tape may be integrated into the appliance. The recording to hard disk enables consumers to “pause” television shows as they air, enabling one to, e.g., answer the telephone without missing a portion of the television show they are viewing. What is actually happening in that situation is that the PVR is continually recording in real-time. When a user “pauses” the television show, the user is instructing the PVR to record the program in the background while freezing the display on the television screen. When the user decides to start watching again, the user is instructing the PVR to play back the show recorded from the hard drive, instead of playing back the television program in real-time. In addition, one can record desired television shows without having to find a suitable videotape. Many PVR devices also use a telephone line or other means to obtain programming information. Thus, a consumer can record a television show merely by finding the show in the programming information and pressing a single button.

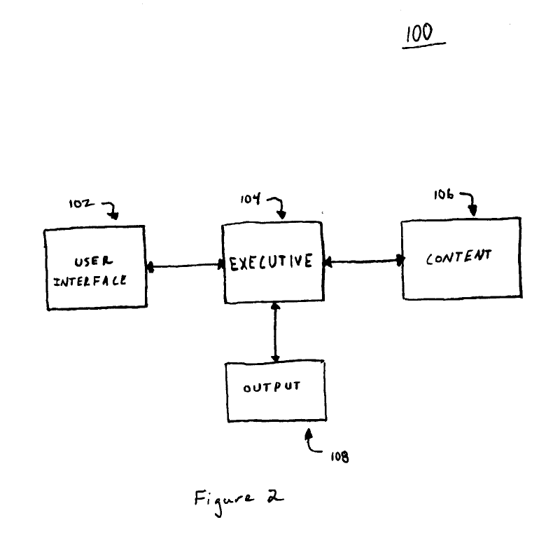

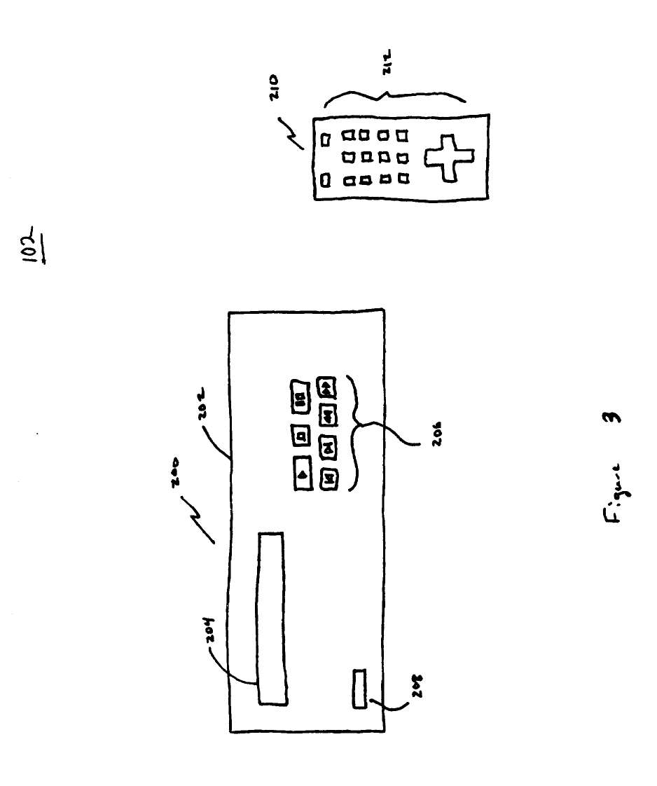

That being said, with reference to FIG. 2, a block diagram of an exemplary embodiment of a multimedia appliance 100 in accordance with the present invention is shown. Multimedia device 100 generally comprises a user interface 102 and an executive 104. As described in additional detail below, executive 104 suitably allows and/or controls manipulation data content 106 in accordance with instructions from a user through user interface 102. That is, user interface 102 suitably allows a user to access appliance 100 and direct it to perform various functions. For example, in a non-limiting embodiment, with momentary reference to FIG. 3, user interface 102 comprises a panel or display (or other input means which suitably allows a user to input and understand the functions of appliance 100). The user accesses interface 102 (e.g., through a remote control, keyboard, mouse, etc.) and instructs appliance 100 that the user desires appliance 100 to perform a particular function. As will be described in more detail below, appliance 100 may be capable of performing nearly any desirable function through upgrades and add-on hardware and software. However, a summary list of functions might include video playback, audio playback, video record, audio record, data storage, broadcast programming access, personal calendar features and many other multimedia features. After/during performance of the functions, the manipulated data content is output 108 in various forms. For example, output 108 might include placement on a storage medium for later retrieval, or alternatively, immediate playback to an output device such as a video monitor or audio speakers.

It should be appreciated that interface 102, executive 104, data content 106 and the various hardware and software components which embody these aspects of the present invention may be realized in many forms; wherein they all reside in the same unit (local) or, alternatively, wherein the components are separate and distinct from one another (remote). For example, appliance 100 may comprise multiple, remotely located components. In one such case, user interface 102 may comprise a display panel similar to a home theater component (VCR, DVD, etc.) front panel with options such as “play”, “record”, “search” and the like. In such embodiments, the display panel interface is likely found in a living room environment similar to other home theater components. This type of interface is accessed through any number of means, but typically would include remote controls, keyboards, joysticks and the like.

Optionally, user interface 102 may comprise an onscreen display (OSD) that interacts with a user control device, including, but not limited to, an infrared remote control unit, a keyboard, or a mouse and displays content on a television monitor to which the appliance is coupled. For example, in the living room environment, interface 102 may include the ability to display commands and functions on a television screen. The user interface may also include a display that is located directly on an embodiment of the present invention. Such a display may also include a series of Liquid Crystal Display (LCD) units or Light Emitting Diode (LED) units which collectively display information including, inter alia, the timing of a particular musical track, the currently selected input, the currently selected television channel, or the current time. Further, in various alternative embodiments, interface 102 may comprise nearly any “interfacing” device. For example, such devices may include PDAs, cellular phones, text messengers, web pads and the like.

Executive 104 is the content manager of the system which suitably determines the functions which appliance 100 has been instructed to be performed and ensures those functions are carried out. Executive 104 is preferably a software enabled manager for organizing, distributing, retrieving or otherwise controlling data (in whatever form the data may be). In its various embodiments, executive 104 may be located at a remote location from interface 102. For example, as mentioned above, while interface 102 may comprise a living room display panel, executive may be embodied in a software application located elsewhere such as on a server or computer in another location (e.g., a home office), so long as executive 104 is suitably connected to interface 102 such that interface 102 and executive can communicate. For example, the components may be connected by standard cable network connections (e.g., via a home network) from both local and remote locations such as local area networks (LAN) and wide area networks (WAN), such that content may be provided from locations other than within the multimedia device itself. Such configurations suitably allow a user to watch or listen and record various analog and digital sources, where a playing device and a recording device (physical or virtual) together create a multiple deck media appliance.

The components may also be connected by any number of wireless means. For example, infrared, wired, or wireless remote controllers can be used as network devices as they often require a predetermined protocol which generally does not conflict with other infrared or wireless devices activated in the same vicinity. Thus, the present invention allows commands and data to be sent or originated through a local or remote networks.

In accordance with another optional aspect of the invention, executive 104 suitably provides the ability to multi-task. That is, executive 104 enables multiple functions to be carried out simultaneously (or near simultaneously). For example, common multi-task functions may include the viewing, listening, multimedia searching and fetching and similar functions while simultaneously providing the ability to record or store other multimedia content.

In accordance with still another optional aspect of the invention, executive 104 suitably provides the ability to customize options for distinct users. For example, in one embodiment of the present invention, a user would input an identification code (numbers, name, etc.) into appliance 100. If executive 104 recognizes the user, various functions might become available. For example, pre-recorded content not previously available to other users might become available. Similarly, appliance 100 may be able to provide recommendations for content of a genre the user has shown a predisposition for (e.g., in the cases of television programming—a type of show).

Similar to interface 102 and executive 104, data content 106 can comprise any number of forms and may be located in any number of locations. Moreover, data content 106 may suitably comprise multiple content streams. For example, data content 106 may comprise fixed sources such as CDs, DVDs or other optical media. Alternatively (or additionally), data content 106 may comprise magnetic media such as video/audio cassettes, hard disk drive media, broadcast or Internet streams. Thus, generally, any data content 106 means/device may fall within the ambit of the appended claims. Moreover, data content 106 may be locate in any number of locations. For example, when data content 106 comprises an optical medium such as a DVD, content 106 may be located locally on media appliance 100 or otherwise in proximity to interface 102 (e.g., in the living room). However, in various alternative embodiments, content 106 may be located remotely from the other components of appliance 100. For example, in one exemplary embodiment, the DVD carrier might be located on the computer containing executive 104. In still another alternative embodiment, content 106 may comprise an entirely remote source of content such as an Internet delivered video and/or audio stream. Thus, in any event, it should be apparent that content 106 may be located anywhere it is feasible to store data.

In accordance with various additional aspects of the present invention, appliance 100 is suitably upgradable. That is, the functionality of appliance 100 may be altered by installing new software on its various components and/or by linking new components to it. For example, should the user wish to add DVD functionality, an appliance software driver directed to such DVD functionality could be loaded onto appliance 100 through a variety of means. For example, the software functionality could be loaded on via a CD/DVD-ROM disc through the optical disc carrier or alternatively, through downloading from the Internet. Likewise, it should be appreciated that nearly any other functionality could be added to the media appliance. For example, software directed to DVD-audio, MP3, CDs, and the like, may likewise be loaded onto the media appliance to change/upgrade the appliance's functionality.

Now, to illustrate an exemplary embodiment of the present invention, the user, through interface 102 might instruct appliance 100 to play a movie from a video content source. In such a case, interface 102 instructs executive 104 that it should perform a video playback function. Executive 104 locates video content 106 in any number of its possible forms. For example, the user may have instructed appliance to play a DVD or to order a “pay-per-view” (PPV)-movie. Executive 104 then determines how content 106 will be located and manipulated. For example, if content 106 is in the form of a DVD, executive 104 will determine that the DVD carrier should be operated and cause the DVD content to be processed and output to a video display. Similarly, in the case of PPV content, the PPV content would be located and directed to the video display. Of course, executive 104 can suitably “order” any number of content manipulation functions. Examples include a user ordering appliance 100 to record content 106 for later retrieval. Other functions might include ordering executive 100 to search for particular genres and content titles.

Additionally, it should be appreciated that the playback function (or other functions) may be accomplished in any number of ways now known or as yet unknown in the art. For example, in various embodiments of the present invention appliance 100 comprises a processor platform with storage media having drivers for various audio and video formats, such as DVD, CD Audio, MP3, MPEG, or any other formats.

In accordance with another aspect of the present invention, “quick boot” systems may be used to speed up the time needed to transition the appliance from an “off” state to state in which the appliance is ready to accept user input.

In accordance now with another exemplary embodiment of the present invention, a multiple deck media appliance which allows various combinations of interconnections, control, signal routing, and management of multimedia content is provided. For example, in this embodiment of the present invention, the appliance comprises a single component containing an optical disc carrier (e.g., a carrier capable of playing DVDs, DVD-ROMs, DVD-Audio, CDs, CD-Rs, CD-RWs, photo CDs, etc.) and a hard drive. Preferably, the DVD carrier and the hard drive are seamlessly integrated such that a user can switch between the various decks and formats as if the multimedia device comprised only a single source.

In accordance with this embodiment of the present invention, the multiple-deck media appliance suitably includes seamless integration of multiple consumer electronic appliance functions through a single front panel or remote control. Additionally, the media appliance may include the ability to route analog or digital audio or perform video switching, as desired. Still further, the media appliance preferably allows the copying of audio or video information with or without fully decrypting, decoding, or re-encoding source information. Thus, preferably, there is no need to decode or encrypt source information and then re-encode the information at the destination device.

With reference to FIG. 3, an exemplary exterior of this embodiment of the present invention is shown. Appliance 200 is similar in appearance to a typical DVD or CD player. Present on the front panel 202 is an optical disc carrier 204 and a plurality of buttons 206. Carrier 204 may be configured to hold and read a DVD or a CD. Carrier 204 may also be configured to hold and read a CD-R or CD-RW. In an alternative embodiment, carrier 204 may also be configured to write to a blank CD-R or CD-RW. The various buttons 206 serve to direct the operations of the appliance in the playback of the disc, e.g., starting playback, stopping playback, and advancing between tracks or scenes. There may also be a power button 208 that switches the appliance into an “off” or “standby” mode. Carrier 204 may suitably be replaced by a number of different means to carry and read a disc, such as a slot in which to insert a disc or a top-loading system. In the alternative, an apparatus configured to accept multiple discs may be used lieu of carrier 204. For example, a “carousel”-type apparatus that accepts multiple discs may be used. In the alternative, multiple carriers or an apparatus with a single carrier that accepts multiple discs may be used. Buttons 206 may also be configured to direct the operations of an internal hard drive of appliance 200. It should be understood that the number and functions of buttons 206 is not limited to that depicted in FIG. 2.

A separate remote control 210 may also be used to control the operation of appliance 200. Such a device, as is known in the art, contains a plurality of buttons 212 which are used to direct the operation of appliance 200. A push of a button 212 results in the transmission of infrared light signals to a receptor on appliance 200 which translates the signal into the appropriate command.

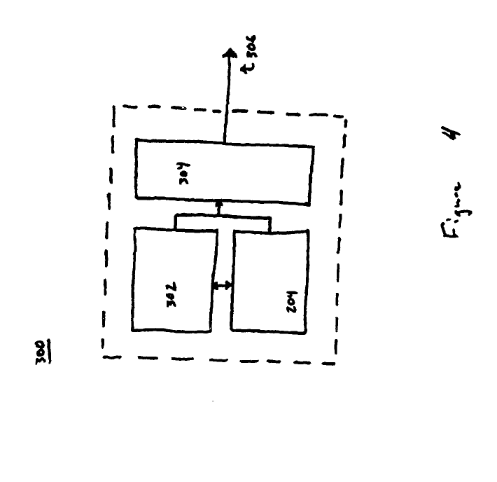

With reference to FIG. 4, a simplified block diagram of the internal layout of an exemplary embodiment of an appliance 300 of the present invention is shown. Carrier 204 is as described above with respect to FIG. 3. Hard drive 302 may be an EIDE hard drive with a large amount of storage capacity, e.g., such as capacities in the range of 20-30 GB. In the alternative, hard drive 302 may be a SCSI hard drive with a similarly large amount of storage capacity. Control unit 304 serves to control the operation of appliance 300. Output controller 306 is configured to forward the output of appliance 306 to another audio/video device.

As mentioned briefly above, hard drive 302 suitably allows the functionality of media appliance 300 to be upgraded and/or changed. For example, in accordance with various aspects of the present invention, the functionality of media appliance 300 is controlled by software drivers. For example, in accordance with one exemplary embodiment, hard drive 302 would suitably be loaded with a DVD software driver for running a DVD carrier. In this exemplary embodiment, optical carrier 204 would derive the capability of playing DVD discs through the installed DVD software driver. If at a later point, a user of media appliance 300 desired media appliance 300 to have the capability of playing, for example, DVD-audio, a software application for a DVD-audio driver could be loaded onto hard drive 302, thus giving optical disc carrier 204 the capability of playing DVD-audio discs. It should be appreciated that the loading of new software onto media appliance 300 can be performed by any means. For example, new software can be loaded via the internet or, alternatively, through optical discs loaded into optical disc carrier 204. Similarly, it should also be appreciated that nearly any type of software may be loaded onto hard drive 302 and still fall within the ambit of the appended claims.

Control unit 304 is configured to perform a variety of different functions. For example, various interface features are controlled by control unit 304. The various interfaces available may include an on-screen display or a display that is physically located on the face of the media appliance. A display on the face of the media appliance may be used to indicate, for example, the timing of the currently playing track on a CD or a scene of a movie DVD. A display on the face of appliance 200 may also indicate the currently selected channel or the channel that is currently being recorded. Control unit 304 also performs the functions as the functions are selected by the user from, for example, a remote control unit, buttons located on the face of the media appliance, or other various input means.

Control unit 304 also performs the functions needed to store data to and read data from hard drive 302. The data stored on hard drive 302 is stored in a variety of different formats, as will be detailed later in this specification. One particular use of hard drive 302 is to store and play back television programs, e.g., in the same manner as a stand-alone PVR device.

Control unit 304 is configured to perform the various decoding functions needed to process the data that is in a variety of formats. For example, control unit 304 performs the processing needed to decode MP3 files into listenable audio files. Control unit 304 also performs the processing needed to process, inter alia, the video and audio contained on a DVD, audio and video contained on a CD, still images stored in a variety of different formats, and the data stored on hard drive 302. Control unit 304 also performs the processing needed to communicate with various networks to which the media appliance is connected.

Control unit 304 may also be configured to control the deck located at carrier 204. The deck is preferably configured to be multiread compatible, i.e., able to read CD-audio, CD-ROM, CD-R, and CD-RW discs. Carrier 204 is also preferably configured to read DVD discs. The deck may also be configured to read DVD-Audio discs, HDCD (High Density Compatible Digital®) encoded CDs, or SACD (Super Audio Compact discs).

The deck may also be configured to write to blank CD-Rs and CD-RWs at a variety of speeds. The media appliance may be configured with multiple CD drives that are simultaneously operable, in order to facilitate the CD-R functionality. In the alternative, music or video files from a CD or a DVD may be copied to hard drive 302 first, then later written to a CD-R or CD-RW. In another aspect of the present invention, one could use music stored hard drive 302 in a jukebox-type mode such that it would no longer be necessary to place the CDs in the drive, music would be played from hard drive 302. The benefits of using hard drive 302 as a jukebox is that a user could store, for example, 30 CDs in a 20 GB of hard drive space if stored uncompressed, and approximately 290 CDs if the audio files are compressed into, e.g., MP3 files. A user could also choose certain music files for storage in the jukebox. In this manner, only a user's favorite tracks would be stored in hard drive 302. The deck may also be configured to write to blank DVD-ROMs or other forms of writable DVDs that are available or may become available in the future.

Control unit 304 may also be configured to perform a variety of different digital signal processing functions. For example, control unit 304 may be configured to perform noise reduction; may contain scratch filters; may contain Q-sound; and may contain a variety of digitally produced surround sound modes. Control unit 304 may also perform equalization for playback in other environments; simulation of acoustic environments; enhancements for surround sound; and other pre-compression processing.

Control unit 304 may also be configured to act in the same manner as a tuner, accepting radio and television signals and processing the signals such that the television signals can be viewed on a television monitor connected to the media appliance and the corresponding audio can be reproduced on one or more loudspeakers coupled to the appliance. The television signals may be in a variety of formats. For example, control unit 304 may be configured to process analog, over-the-air radio and television signals; digital, over-the-air radio and television signals; analog and digital cable television and radio signals; and analog and digital satellite television signals. Control unit 304 may also be configured to process high-definition television signals for the latest generation of high-definition television (“HDTV”) sets for output to compatible HDTV monitors attached to the media appliance.

Control unit 304 may comprise a microprocessor or a plurality of processors situated on a motherboard or other printed circuit board (PCB) surface. For example, control unit 304 may contain an Intel Architecture engine. Control unit 304 may also comprise an amount of Random Access Memory (RAM) which is accessible by the microprocessor for use in performing various functions.

Control unit 304 may also comprise specialized processors to perform a variety of functions. For example, there may be a specific processor or board which contains an MPEG-2 decoder for use with DVD-Video. There may also be a separate board which translates data to a video format which is usable by a typical consumer television monitor. One or more of the above boards may also perform a de-interlacing function, for translating interlaced video into non-interlaced form, for those television monitors which accept non-interlaced signals. Current NTSC (National Television System Committee) standards use approximately 59.94 “fields” per second. Each field comprises half of the image, with two fields interlacing with each other to display an image. Therefore, two fields comprise the television equivalent of a film “frame” (approximately 29.97 “frames” per second). With the new HDTV standard is the ability to show a complete image at the rate of 29.97 images per second, as opposed to showing two interlaced fields at 59.94 fields per second. When showing an interlaced image on a progressive television monitor, the image must be de-interlaced first to display properly. A board or processor configured to perform that function may be present in control unit 304.

Another possible function for appliance 200 is a line-doubling function. While most television signals are limited to 525 lines of resolution, certain television monitors are able to display more lines of resolution. A line-doubling function interpolates additional lines to present a higher quality signal to those types of television monitors.

As mentioned above, an optional feature that may be present in a preferred embodiment of the present invention is a Quick-Boot feature that enables the processor of control unit 304 to transition from an “off” state to being ready to respond to commands in a relatively short amount of time. The quick-boot functionality may be accomplished in a number of different manners. For example, a typical processor requires an operating system to perform certain input/output functions and to give various functionality elements to the processor. The media appliance may contain a Linux operating system in a stripped-down form for embedded applications. Such a custom Linux platform may be able to be booted in as little as five seconds.

One of the benefits of using a relatively common operating system such as Linux is that the reprogramming and upgrading of various software is greatly simplified by the availability of a large community of programmers.

It may also be desirable to have a media appliance with the capability of displaying a variety of files that can be transmitted via the Internet in various formats. For example, there are a variety of different formats for audio files, such as MP3, AAC, MS Audio, MS Media, Liquid Audio, and Real Audio. Control unit 304 can be configured to process those files and playback the audio over the attached loudspeakers.

There are also a variety of different video file formats, such as MPEG, QuickTime, Vivo, Real Video, and Windows Media Player. Control unit 304 can be configured to process those files and playback the video over an attached television set and the audio over an attached set of speakers.

There are a variety of different file formats available for graphic files, such as JPEG, GIF, and BMP. Control unit 304 can be configured to process those files and display the graphics on a television set attached to the media appliance.

Control unit 304 requires various pieces of software to perform some of the above-described functions. The software is typically provided in the product as shipped. Control unit 304 may also be upgradable. The upgrade may be performed through the use of downloads. The upgrades may concern product updates to correct unforeseen problems. The upgrades may also add new functionality to media appliance 200.

While there are many function that can be performed by control unit 304, as detailed above, it may not be economically desirable to include all of the above listed functionality. For example, it may be more cost effective to include a CD/DVD drive instead of one capable of writing to CD-R. For cost purposes, the appliance may be configured to not contain any HDTV functionality in control unit 304. Along with the upgradability described above, media appliance 200 may be configured to allow upgrades to the hardware as well. For example, as described above, if a device that writes to CD-R/CD-RW was not included with the product as purchased, a consumer may be able to add such a device at a later time, along with the software needed to operate such a device. Thus a manufacturer can offer a media appliance at a variety of different price points merely by inserting different components into media appliance 200.

An on-screen display may include a menu that can be displayed by a television monitor to which the media appliance is connected. The menu can be used, for example, to select a program to be watched, to select a song to be played from hard drive 302 or carrier 204, or to select a particular scene from a DVD movie located in carrier 204.

There are various types of inputs and outputs that may be present in an exemplary embodiment of the present invention. For example, because the media appliance can play back video images on a television monitor, there must be an interface between the media appliance and a television monitor. This interface may be in the form of an RF connector, such as the “F”-type connectors typically used to connect a television to an antenna via a coaxial cable. In the alternative, there are higher quality methods of interfacing with a television monitor. These interfaces include, in ascending order of video quality, composite video connections, S-video connections, and component video connections. The above-described interfaces may be in the form of “RCA”-type connectors, “BNC”-type connectors, “SCART”-type connectors, or other forms of connectors that currently exist or may be developed in the future. The above description of video connectors is intended to be illustrative and not limiting; other forms of interfacing video that currently exist or may exist in the future may also be used with this invention with no effect on the operation of an exemplary embodiment.

There are various types of audio interfaces available as well. For example, the media appliance may be coupled to an amplifier which is, in turn, coupled to one or more loudspeakers. The media appliance may have stereo analog audio outputs for a left channel and a right channel. Types of analog outputs include, inter alia, the RCA type or the XLR type. One embodiment of the media appliance may contain a surround sound decoder and, thus, may contain three or more analog audio outputs. The media appliance may also contain a digital output. Raw digital audio in PCM, MLP, Dolby Digital (AC-3), DTS, or MPEG-2 format may be output via a digital connector to a surround-sound processor or a digital/analog converter. The digital output may use a S/P DIF coaxial format, which uses an RCA connector. In addition or in the alternative, the digital output may be in the TOSLINK format, with a fiber-optic connection. The above-described digital output would be transmitted to a processor for the processing of the formatted digital signal.

An embodiment of the present invention may also contain a power amplifier. This embodiment would thus contain several outputs, each of which could be connected directly to a loudspeaker. There are several different outputs formats available for connection to a loudspeaker. For example, spring-loaded outputs accept pins or bare wire; barrier strips accept bare wire or spade lugs; screws which accept spade lugs or bare wire; 5-way binding posts accept pins, bare wire, spade lugs, and banana plugs; ¼ inch outputs accept ¼ inch phono plugs; XLR outputs accept XLR cables; and Speakon connectors accepts specific twist-lock connectors. Various other forms of speaker connectors may also be used without adversely affecting the operation of this embodiment of the present invention.

An embodiment which contains a power amplifier also contains pre-amplification features, such as the ability to switch among various sources, control the output level, and perform various signal processing functions.

There may be a plurality of additional ports that can be used for other various input and output functions. For example, in an embodiment including a SCSI hard drive, there may be an external SCSI port such that a user can add additional storage. There may be one or more USB ports that can be used for a variety of functions. For example, one can add a mouse or keyboard, printer, scanner, modem, still cameras, game controllers, or a variety of other devices to the media appliance. There may be one or more IEEE 1394 ports (also known as “FireWire” ports) available. FireWire ports can be used, for example, to load movies from a digital camcorder, or to attach an external hard drive.

There may also be an RJ-45 connector such that the media appliance can be connected to a local area network (LAN). By connecting to a LAN, the media appliance can be connected to transfer files to and from another computer. Another use for an RJ-45 connector is to connect to a cable modem, DSL, or other broadband Internet service. In a similar manner, the media appliance may include other types of connectors that are commonly used, now or in the future, to connect to a LAN. There may also be an RJ-11 connector if the media appliance is configured with a built-in modem.

When connected to a network, the media appliance may gain a number of additional functions. For example, the media appliance may be able to use the hard drives of other devices connected to the network for increased capacity. The media appliance may also be coupled to video cameras, exercise equipment, or even a 200-disc carousel.

The connections available on an embodiment of the present invention ensure that future products, both digital and analog, can be connected to the present invention. Furthermore, in the event that a new medium is developed, a user need only update the software present on the media appliance to gain support for the new product.

The media appliance, as a whole, may also be upgradeable through the use of interchangeable modules. For example, several of the various connections detailed above may be located on a replaceable card. Therefore, if a user wishes to add a new interface, he may do so merely by adding a new module or replacing an existing module. For example, if a user does not have a television monitor that accepts component video inputs, the user may wish to purchase a media appliance that contains S-video outputs but no component video outputs. In the event the user obtains a television that accepts component video inputs, the user may wish to obtain a module for the media appliance that contains component video outputs.

Thus, the forgoing combination product allows the user to carry out multiple tasks, such as watching or listening to one source while simultaneously recording or searching other information to be viewed or listened at a later time. Additionally, the interconnection of the multiple multimedia devices is performed such that each device is fully knowledgeable about the action of the other, thus suitably preventing any conflicts that could arise between the actions of each device.

Lastly, while the principles of the invention have been described in illustrative embodiments, many combinations and modifications of the above-described structures, arrangements, proportions, the elements, materials, and components, used in the practice of the invention, in addition to those not specifically described, may be varied and particularly adapted for a specific environment and operating requirement without departing from those principles.

We claim:

1. A multimedia appliance comprising:
an executive for locating and directing manipulation of data content to create manipulated data;
a user interface for directing said executive; and
an output for conveying said manipulated data.

2. The multimedia appliance of claim 1 wherein said executive, said user interface and said output are remote from one another.

3. The multimedia appliance of claim 1 wherein said executive, said user interface and said output are on a local device.

4. The multimedia appliance of claim 1 wherein said user interface is a remote control.

5. The multimedia appliance of claim 1 wherein said user interface is an on screen display.

6. The multimedia appliance of claim 1 wherein said user interface is a keyboard.

7. The multimedia appliance of claim 1 wherein said executive determines a requested function and ensures said function is carried out.

8. The multimedia appliance of claim 1 wherein said executive is a software enabled manager for organizing, distributing, retrieving or otherwise controlling data.

9. The multimedia appliance of claim 1 wherein said executive has multi-tasking functionality.

10. The multimedia appliance of claim 1 wherein said executive can distinguish between users.

11. The multimedia appliance of claim 10 wherein said executive distinguishes users based on an identification code.

12. The multimedia appliance of claim 11 wherein said identification code allows said executive to provide content recommendations.

13. The multimedia appliance of claim 2 wherein said executive, said user interface and said output are remote from one another are connected by a cable network.

14. The multimedia appliance of claim 2 wherein said executive, said user interface and said output are remote from one another are connected by a wireless network.

15. The multimedia appliance of claim 1 further comprising a display unit.

16. The multimedia appliance of claim 15 wherein said display unit comprises an LCD display.

17. The multimedia appliance of claim 16 wherein said LCD display is configured to display a spectrum analysis of various data.

18. An integrated media apparatus comprising:
a drive configured to read a first data from a disc-based medium;
a storage medium for a second data;
a processor for processing at least one of said first and said second data to produce an output signal; and
an output for conveying said output signal.

19. The apparatus of claim 18 wherein said drive is a DVD carrier.

20. The apparatus of claim 18 wherein said drive is a CD carrier.

21. The apparatus of claim 18 wherein said drive can read at least one of the following: CD-ROM, CD-R, CD-RW, PhotoCD, and VideoCD.

22. The apparatus of claim 18 wherein said output comprises a video output.

23. The apparatus of claim 22 wherein said video output comprises an S-video connector.

24. The apparatus of claim 22 wherein said video output comprises an RF video connector.

25. The apparatus of claim 18 wherein said output signal is an analog audio output signal.

26. The apparatus of claim 18 wherein said output comprises a plurality of RCA connectors.

27. The apparatus of claim 25 wherein,
said processor comprises an amplifier configured to produce said analog audio output signal in a format usable by loudspeakers; and
said output further comprises a plurality of loudspeaker connectors.

28. The apparatus of claim 18 wherein said output signal comprises a digital audio output signal.

29. The apparatus of claim 18 wherein said output comprises a fiber-optic connector.

30. The apparatus of claim 28 wherein said digital audio output signal further comprises surround-sound encoded digital data.

31. The apparatus of claim 18 wherein said output comprises at least one USB port configured to operate in both an input mode and an output mode.

32. The apparatus of claim 18 wherein said output comprises at least one IEEE-1394 port configured to operate in both an input mode and an output mode.

33. The apparatus of claim 18 wherein said output comprises a printer port.

34. The apparatus of claim 18 wherein said storage medium comprises a hard disk drive.

35. The apparatus of claim 18 wherein said processor is configured to store audio data onto said storage medium.

36. The apparatus of claim 18 wherein said processor is configured to store video data onto said storage medium.

37. The apparatus of claim 18 further comprising a tape drive configured to read data from a magnetic tape-based medium.

38. The apparatus of claim 37 wherein said tape drive is configured to read a video cassette tape.

39. The apparatus of claim 37 wherein said tape drive is configured to read data from at least one of a VHS media, an 8 mm media, a DV media, a U-Matic media, a Beta media, and a mini-DV media.

40. The apparatus of claim 37 wherein said tape drive is configured to read an audio tape.

41. The apparatus of claim 37 wherein said tape drive is configured read data from at least one of an analog cassette, a digital cassette and an open-reel tape.

42. The apparatus of claim 18 further comprising an input interface.

43. The apparatus of claim 42 wherein said input interface comprises a remote control unit.

44. The apparatus of claim 42 wherein said input interface comprises a keyboard unit.

45. The apparatus of claim 42 wherein said input interface comprises a pointing device.

46. The apparatus of claim 18 further comprising a display unit.

47. The apparatus of claim 46 wherein said display unit comprises an LCD display.

48. The apparatus of claim 47 wherein said LCD display is configured to display a spectrum analysis of various data.

49. The apparatus of claim 18 further comprising a tuner.

50. The apparatus of claim 49 wherein said tuner is configured to process analog audio radio signals.

51. The apparatus of claim 49 wherein said tuner is configured to process digital audio radio signals.

52. The apparatus of claim 49 wherein said tuner is configured to process television signals.
